(19) United States
(12) Patent Application Publication
(10) Pub. No.: US 2004/0211466 A1
(43) Pub. Date: Oct. 28, 2004

(54) Gas filling device

(76) Inventor: Setsuhiro Saheki, Gifu-shi (JP)

Correspondence Address: SHERIDAN ROSS PC, 1560 BROADWAY, SUITE 1200, DENVER, CO, 80202

(21) Appl. No.: 10/752,932

(22) Filed: Jan. 6, 2004

(30) Foreign Application Priority Data
Apr. 22, 2003 (JP) 2003-117479

(51) Int. Cl. F16K 15/20

(52) U.S. Cl. 137/223

(57) ABSTRACT

An air filling device includes a first air chuck and a second air chuck. The first air chuck is fitted to a tire valve of a front wheel, and the second air chuck is fitted to a tire valve of a rear wheel. The air pressure of the front tire is set to, for example, 800 [kPa] with a first pressure regulator. When the carried load is maximum, the air pressure of the rear tire is set to, for example, 1000 [kPa] with a second pressure regulator. The pressure of the front wheel is adjusted using the first air chuck, and the pressure of the rear wheel is adjusted using the second air chuck. Since the air pressure of the front tire and the rear tire can be adjusted simultaneously, the period of time required for adjusting the air pressure is shortened.

### BACKGROUND OF THE INVENTION

The present invention relates to a gas filling device for filing a vehicle tire with a predetermined gas.

For example, Japanese Laid-Open Patent Publication No. 8-169220 discloses an air filling device for filling vehicle tires with air. The air filling device has a pressure regulator for regulating air pressure, and an air chuck. The air chuck contacts a tire valve and adjusts the air pressure of a tire. After setting a target pressure value with the pressure regulator, the air chuck is brought into contact with the tire valve. Then, the air filling device adjusts the pressure of the tire. Specifically, the air filling device sends air from an air compressor to the tire. Also, the air filling device releases air in the tire through the air chuck. The air chuck is applied to any of the tires of a vehicle. The air filling device is therefore capable of adjusting the air pressure in the tires of any types of vehicles, for example, a four-wheeled passenger car, a multi-wheeled truck.

In a multi-wheeled truck, the air pressure of front wheels and the air pressure of rear wheels are adjusted to be different depending on the carried load. Even in this case, the pressure of all the tires must be adjusted with a single air chuck, while changing the target pressure of the pressure regulator. Specifically, the pressure of the front tires needs to be set, for example, to 800 [kPa] regardless of the carried load. On the other hand, the pressure of the rear tires needs to be set to 1000 [kPa] when the carried load is maximum, and to 800 [kPa] when there is no carried load. Therefore, adjustment of tire air pressure for a multi-wheeled vehicle is complicated and requires an extended period of time.

### SUMMARY OF THE INVENTION

Accordingly, it is an objective of the present invention to provide a gas filling device that is capable of quickly and easily adjusting the pressure of tires.

To achieve the foregoing and other objectives and in accordance with the purpose of the present invention, a gas filling device for filling plurality of tires with gas is provided. The gas filling device includes a gas supply source, a plurality of pressure regulators, and a plurality of gas chucks. The plurality of pressure regulators are connected to the gas supply source. Each pressure regulator sets the pressure of gas supplied from the gas supply source to a predetermined target pressure. Each gas chuck is connected to one of the pressure regulators and a tire. Each gas chuck permits gas to be supplied to the connected tire so that the pressure of the tire becomes the target pressure set by the corresponding pressure regulator.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a diagrammatic view showing an air filling device;

FIG. 2(a) is a cross-sectional view illustrating a distal portion (inner diameter r1, depth d1) of an air chuck;

FIG. 2(b) is a cross-sectional view illustrating a distal portion (inner diameter r2, depth d2) of an air chuck;

FIG. 3(a) is a cross-sectional view illustrating a threaded portion (outer diameter r1, depth d1) of a tire valve;

FIG. 3(b) is a cross-sectional view illustrating a threaded portion (outer diameter r2, depth d2) of a tire valve; and

FIG. 4 is a diagrammatic view showing tires and tire valves installed in the tires.

### DETAILED DESCRIPTION OF THE PREFERRED EMBODIMENTS

A gas filling device according to one embodiment will now be described with reference to the drawings.

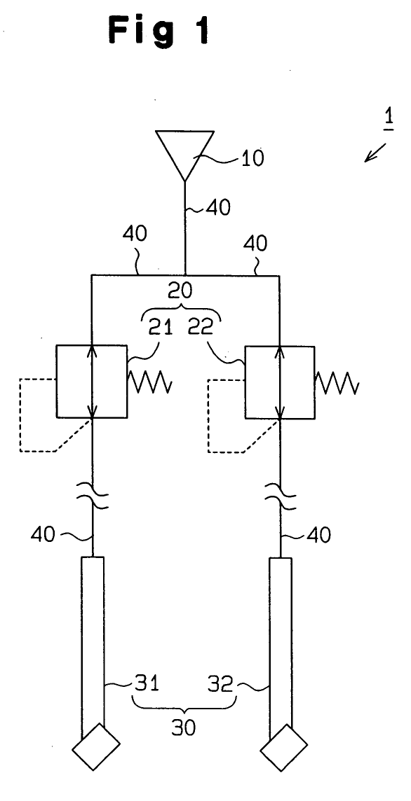

As shown in FIG. 1, the gas filling device, which is an air filling device 1, has an air supply source, which is an air compressor 10, first and second pressure regulators 21, 22, and first and second air chucks 31, 32. The pressure regulators 21, 22 each set a predetermined air pressure. Each air chuck 31, 32 contacts a tire valve and adjusts the pressure of the tire. The air chucks 31, 32 function as a gas chuck. The air compressor 10 and the pressure regulators 21, 22 are connected to each other with flexible rubber hoses 40. Also, the pressure regulators 21, 22 and the air chucks 31, 32 are connected to each other with tube bodies, which are flexible rubber hoses 40.

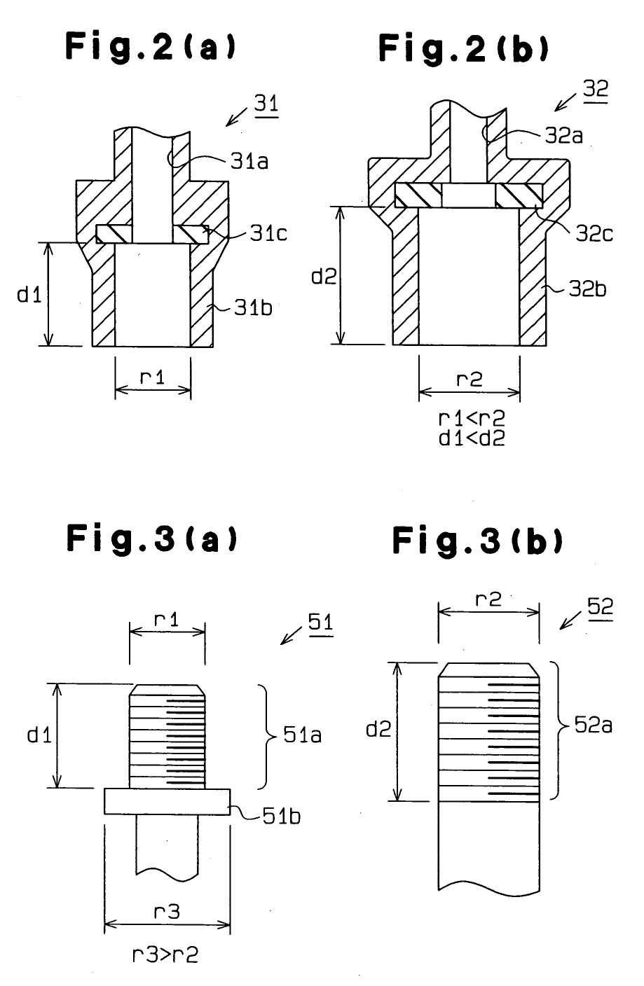

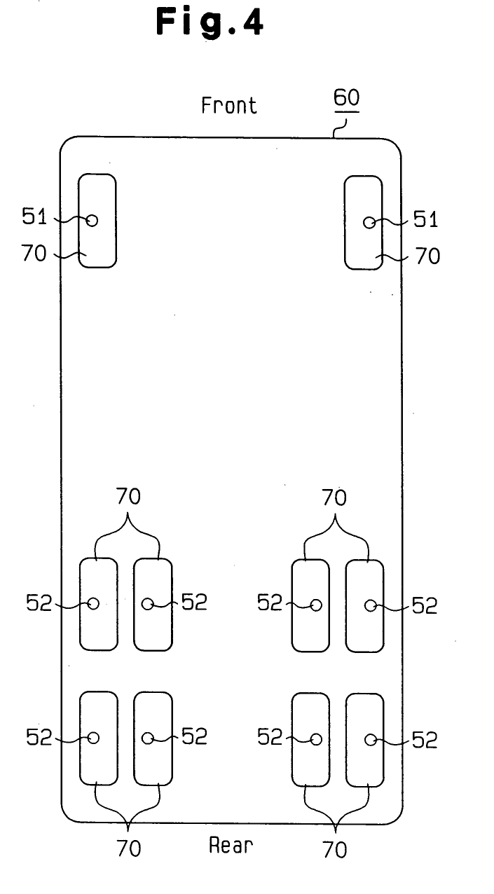

The structure of the air chucks 31, 32 will now be described with reference to FIGS. 2(a) and 2(b).

As shown in FIG. 2(a), a passage 31a is formed in the first air chuck 31. A deflator (not shown) is provided in the passage 31a. The deflector presses a valve core incorporated in the tire valve. A fitting portion, which is a distal portion 31b, is formed at the distal end of the first air chuck 31. The distal portion 31b communicates with the passage 31a. The distal portion 31b is cylindrical and has an inner diameter of r1, and a depth d1. At the bottom of the distal portion 31b, or at the boundary between the passage 31a and the distal portion 31b, a sealing member, which is an annular rubber 31c, is provided.

As shown in FIG. 2(b), a passage 32a is formed in the second air chuck 32. A deflator (not shown) is provided in the passage 32a. The deflector presses a valve core incorporated in the tire valve. A fitting portion, which is a distal portion 32b, is formed at the distal end of the second air chuck 32. The distal portion 32b communicates with the passage 32a. The distal portion 32b is cylindrical and has an inner diameter of r2, and a depth d2. The inner diameter r2 of the second air chuck 32 is greater than the inner diameter r1 of the first air chuck 31. The depth d2 of the second air chuck 32 is longer than the depth d1 of the first air chuck 31. At the bottom of the distal portion 32b, or at the boundary between the passage 32a and the distal portion 32b, a sealing member, which is an annular rubber 32c, is provided.

The structure of the tire valves 51, 52 will now be described with reference to FIG. 3.

As shown in FIG. 3(a), a threaded portion 51a is formed at a distal end of the tire valve 51. A valve cap (not shown) is engaged with the threaded portion 51a. The threaded portion 51a has an outer diameter of r1, and a length of d1. A contact plate 51b is located below the threaded portion 51a. The contact plate 51b has an outer diameter of r3. The outer diameter r3 of the contact plate 51b is greater than the inner diameter r2 of the second air chuck 32.

As shown in FIG. 3(b), a threaded portion 52a is formed at a distal end of the tire valve 52. A valve cap (not shown) is engaged with the threaded portion 52a. The threaded portion 52a has an outer diameter of r2, and a length of d2.

The relationship between the air chucks 31, 32 and the tire valves 51, 52 will now be described with reference to FIGS. 2(a) to 3(b).

The inner diameter r1 of the distal portion 31b of the first air chuck 31 shown in FIG. 2(a) is the same as the outer diameter r1 of the threaded portion 51a of the tire valve 51 shown in FIG. 3(a). The depth d1 of the distal portion 31b of the first air chuck 31 shown in FIG. 2(a) is the same as the depth d1 of the threaded portion 51a of the tire valve 51 shown in FIG. 3(a).

The cavity of the distal portion 31b of the first air chuck 31, or a cylindrical receiving portion, receives the threaded portion 51a.

Thus, when the distal portion 31b of the first air chuck 31 is fitted in the threaded portion 51a of the tire valve 51, the distal end of the threaded portion 51a contacts the annular rubber 31c. This permits the air chuck 31 to hermetically contact the tire valve 51. At this time, the deflator (not shown) provided in the passage 31a presses a valve core (not shown) incorporated in the tire valve 51. Therefore, the pressure of the tire having the tire valve 51 is adjusted based on the pressure of the tire and the reference pressure of the second pressure regulator 21. Thus, the pressure of the tire having the tire valve 51 is adjusted to the set pressure of the second pressure regulator 21.

The inner diameter r2 of the distal portion 32b of the second air chuck 32 shown in FIG. 2(b) is the same as the outer diameter r2 of the threaded portion 52a of the tire valve 52 shown in FIG. 3(b). The depth d2 of the distal portion 32b of the second air chuck 32 shown in FIG. 2(b) is the same as the depth d2 of the threaded portion 52a of the tire valve 52 shown in FIG. 3(b).

The cavity of the distal portion 32b of the second air chuck 32, or a cylindrical receiving portion, receives the threaded portion 52a.

Thus, when the distal portion 32b of the second air chuck 32 is fitted in the threaded portion 52a of the tire valve 52, the distal end of the threaded portion 52a contacts the annular rubber 32c. Therefore, the hermeticity between the second air chuck 32 and the tire valve 52 is guaranteed. At this time, the deflator (not shown) provided in the passage 32a presses a valve core (not shown) incorporated in the tire valve 52. Therefore, the pressure of the tire having the tire valve 52 is adjusted based on the pressure of the tire and the reference pressure of the second pressure regulator 22. Thus, the pressure of the tire having the tire valve 52 is adjusted to the reference pressure of the second pressure regulator 22.

Suppose a user attempts to adjust the pressure of a tire having the tire valve 52 shown in FIG. 3(b) using the first air chuck 31 shown in FIG. 2(a). However, the inner diameter r1 of the distal portion 31b of the first air chuck 31 is less than the outer diameter r2 of the threaded portion 52a of the tire valve 52. Therefore, the distal portion 31b of the first air chuck 31 cannot be fitted in the threaded portion 52a of the tire valve 52. Therefore, the first air chuck 31 cannot be used for supplying air to a tire having the tire valve 52.

Suppose a user attempts to adjust the pressure of a tire having the tire valve 51 shown in FIG. 3(a) using the second air chuck 32 shown in FIG. 2(b). However, the depth d2 the distal portion 32b of the second air chuck 32 is longer than the length d1 of the threaded portion 51a of the tire valve 51. In addition, the inner diameter of the distal portion 32b of the second air chuck 32 is less than the outer diameter r3 of the contact plate 51b of the tire valve 51.

Thus, when the second air chuck 32 is fitted in the tire valve 51, the distal portion 32b of the second air chuck 32 contacts the contact plate 51b. As a result, even if the second air chuck 32 is fitted in the tire valve 51, the distal end of the threaded portion 51a does not contact the rubber 32c of the second air chuck 32. Therefore, the second air chuck 32 cannot be used for supplying air to a tire having the tire valve 51.

The first air chuck 31 permits air to be supplied to a tire that has the threaded portion 51a of the tire valve 51.

On the other hand, the second air chuck 32 permits air to be supplied to a tire that has the threaded portion 51a of the tire valve 52. Therefore, the air chucks 31, 32 can be used for adjusting the pressure of a tire having the tire valve 51 and a tire having the tire valves 51, 52.

The operation of the air filling device 1 will now be described.

A case where the present invention is applied to a vehicle 60 (multi-wheeled) will be discussed below. The vehicle 60 has two front tires 70, and eight rear tires 70. Each front tire 70 of the vehicle 60 has the tire valve 51. Each rear tire 70 of the vehicle 60 has the tire valve 52. Regardless of the carried load, the front tires 70 set a pressure of 800 [kPa]. On the other hand, the pressure of each rear tire 70 is set to 1000 [kPa] when the carried load is maximum, and to 800 [kPa] when there is no carried load.

Adjustment of the pressure of the tires 70 using the air filling device 1 is performed in the following manner. First, the reference pressure of the first pressure regulator 21 for adjusting the pressure of the front tires 70 is set to 800 [kPa]. Then, if the carried load is maximum, the reference pressure of the second pressure regulator 22 for adjusting the pressure of the rear tires 70 is set to 1000 [kPa]. If there is no carried load, the reference pressure of the second pressure regulator 22 for adjusting the pressure of the rear tires 70 is set to 800 [kPa]. Then, the pressure of the front tires 70 is adjusted using the first air chuck 31, and the pressure of the rear tires 70 is adjusted using the second air chuck 32.

This embodiment has the following advantages.

As shown in FIGS. 3(a) and 3(b), the shape of the tire valve 51, which is used for the front tires 70, is different from the shape of the tire valve 52, which is used for the rear tires 70. Therefore, if the settings of the pressure regulators 21, 22 are accurately done, adjustment of the front tires 70 and the rear tires 70 is not erroneously performed. Accordingly, the front tires 70 and the rear tires 70 maintain proper levels of air pressure. As a result, the rolling resistance of the tires 70 is reduced. This improves the fuel economy of the vehicle 60.

Further, the pressure of the front tires 70 and the pressure of the rear tires 70 can be simultaneously adjusted using the air chucks 31, 32. This shortens the time required for adjusting the pressure.

(2) The distal portion 31b of the first air chuck 31 is fitted in the threaded portion 51a of the tire valve 51. The distal portion 32b of the second air chuck 32 is fitted in the threaded portion 52a of the tire valve 52. However, the distal portion 31b of the first air chuck 31 cannot be fitted in the threaded portion 52a of the tire valve 52. The distal portion 32b of the second air chuck 32 cannot be fitted in the threaded portion 51a of the tire valve 51. In other words, the distal portion 31b, 32b of the first and second air chucks 31, 32 conform to the shape of the first and tire valves 51, 52, respectively. Therefore, if the settings of the pressure regulators 21, 22 are accurately done, adjustment of the front tires 70 having the tire valves 51 and the rear tires 70 having the tire valves 52 is not erroneously performed. Accordingly, the front tires 70 and the rear tires 70 maintain proper levels of air pressure. As a result, the rolling resistance of the tires 70 is reduced. This improves the fuel economy of the vehicle 60.

It should be apparent to those skilled in the art that the present invention may be embodied in many other specific forms without departing from the spirit or scope of the invention. Particularly, it should be understood that the invention may be embodied in the following forms.

Gas filling the tires 70 need not be air, which contains 78% of nitrogen. For example, nitrogen gas (100% of nitrogen) may be used.

The number of the pressure regulators 21, 22 need not be two, but may be three or more.

The shapes of the distal portion 31b, 32b of the air chucks 31, 32 are not limited to those shown in FIGS. 2(a) and 2(b). The shapes of the distal portions 31b, 32b of the air chucks 31, 32 may be changed as long as the shapes conform to the shapes of fitted portions of the tire valves 51, 52.

The air filling device 1 of the illustrated embodiment may be used for simultaneously filling air to tires 70 of two or more vehicles (for example, a passenger car and a truck).

Although the inner diameter r1 of the first air chuck 31 and the outer diameter r1 of the tire valve 51 are referred to as the same, the description does not imply that the inner diameter r1 and the outer diameter r1 are exactly the same. That is, the description that the inner diameter r1 and the outer diameter r1 are the same includes a case that the inner diameter r1 and the outer diameter r1 are different such that a slight space is created between the distal portion 31b and the threaded portion 51a to allow the insertion of the threaded portion 51a into the distal portion 31b.

Therefore, the present examples and embodiments are to be considered as illustrative and not restrictive and the invention is not to be limited to the details given herein, but may be modified within the scope and equivalence of the appended claims.

1. A gas filling device for filling plurality of tires with gas, the gas filling device comprising:
a gas supply source;
a plurality of pressure regulators connected to the gas supply source, wherein each pressure regulator sets the pressure of gas supplied from the gas supply source to a predetermined target pressure; and
a plurality of gas chucks, wherein each gas chuck is connected to one of the pressure regulators and a tire, wherein each gas chuck permits gas to be supplied to the connected tire so that the pressure of the tire becomes the target pressure set by the corresponding pressure regulator.

2. The gas filling device according to claim 1, wherein eachgas chuck has a fitting portion that is fitted to a tire valve located on the corresponding tire.

3. The gas filling device according to claim 2, wherein the fitting portions of at least two of the gas chucks have different forms or sizes such that the fitting portions can be fitted to different kinds of tire valves.

4. The gas filling device according to claim 2, wherein the fitting portion of each gas chuck has a cylindrical receiving portion to receive a tire valve.

5. The gas filling device according to claim 4, wherein the cylindrical receiving portions of the fitting portions of at least two gas chucks have different inner diameters or depths such that the cylindrical receiving portions can be fitted to different kinds of tire valves.

6. The gas filling device according to claim 4, wherein a sealing member is located in the cylindrical receiving portion of each gas chuck, wherein, when the fitting portion is fitted to a tire valve, the sealing member seals between the tire valve and the fitting portion.

7. The gas filling device according to claim 1, further comprising a plurality of tube bodies, wherein the tube bodies extend from the gas supply source and permit gas to pass through, wherein each pressure regulator is located in one of the tube bodies, and wherein each gas chuck is provided at a distal end of one of the tub bodies.

8. An air filling device for filling plurality of tires with air, the air filling device comprising:
an air compressor;
a plurality of pressure regulators connected to the air compressor, wherein each pressure regulator sets the pressure of gas supplied from the gas supply source to a predetermined target pressure; and
a plurality of air chucks, wherein each air chuck is connected to one of the pressure regulators and a tire, wherein each air chuck has a passage for permitting the flow of air, wherein each air chuck permits gas to be supplied to the connected tire so that the pressure of the tire becomes the target pressure set by the corresponding pressure regulator.

9. The air filling device according to claim 8, wherein each air chuck has a fitting portion that is fitted to a tire valve located on the corresponding tire.

10. The air filling device according to claim 9, wherein the fitting portions of at least two of the air chucks have different forms or sizes such that the fitting portions can be fitted to different kinds of tire valves.

11. The air filling device according to claim 9, wherein the fitting portion of each air chuck has a cylindrical receiving portion to receive a tire valve.

12. The air filling device according to claim 11, wherein the cylindrical receiving portions of the fitting portions of at least two air chucks have different inner diameters or depths such that the cylindrical receiving portions can be fitted to different kinds of tire valves.

13. The air filling device according to claim 11, wherein a sealing member is located in the cylindrical receiving portion of each air chuck, wherein, when the fitting portion is fitted to a tire valve, the sealing member seals between the tire valve and the fitting portion.

14. The air filling device according to claim 8, further comprising a plurality of tube bodies, wherein the tube bodies extend from the air compressor and permit air to pass through, wherein each pressure regulator is located in one of the tube bodies, and wherein each air chuck is provided at a distal end of one of the tub bodies.
